(19) United States
(12) Patent Application Publication
(10) Pub. No.: US 2016/0134140 A1
(43) Pub. Date: May 12, 2016

(54) Charging Station

(71) Applicants: John Tittle, Brooklyn, MI (US); Terry Richards, Pinckney, MI (US); Lauren Flanagan, Douglas, MI (US)

(72) Inventors: John Tittle, Brooklyn, MI (US); Terry Richards, Pinckney, MI (US); Lauren Flanagan, Douglas, MI (US)

(21) Appl. No.: 14/536,419

(22) Filed: Nov. 7, 2014

(51) Int. Cl. H02J 7/00; H02J 7/35

(52) U.S. Cl. CPC H02J 7/0042; H02J 7/35

(57) ABSTRACT

A charging station having a housing, which includes an interior portion and at least one movable panel for enclosing the interior portion. The movable panel(s) include an energy receiving component and is movable between a first position and a second position. In the first position, the energy receiving component is exposed to an external energy source. In the second position, the energy receiving component is enclosed in the interior portion of the housing.

### TECHNICAL FIELD

In some implementations, the subject matter described herein generally relates to a charging station for generating electric power, and in particular, to a portable, transportable and independent power system to provide electrical power and/or wireless communication to various equipment.

### BACKGROUND

In today's world, sustainability and operability of buildings, factories, hospitals production lines, homes, vehicles, consumer goods, equipment, services, etc. (whether civilian and/or military use) depend on availability of electrical power. In some cases, electrical power may be needed on an urgent basis, for example, to perform a life-saving surgery for a wounded soldier in a military field hospital that may be located in a war zone. Alternatively, immediate availability of electrical power may be required for uninterrupted operation of vehicles.

In many locations throughout the world, electric charging stations, whether for use by electric vehicles, consumer devices, etc., have been setup to provide immediate availability of electrical power for recharging such vehicles, devices, etc. These stations can be part of an infrastructure that supplies electric energy for the recharging of plug-in electric vehicles, all-electric cars, electric vehicles, plug-in hybrids, consumer devices. Many such charging stations are on-street facilities provided by electric utility companies. The stations include a range of heavy duty or special connectors and/or allow charging without a direct physical connection, e.g., such as by using inductive charging mats. Some stations simply allow swapping of batteries instead of charging.

To provide electrical power to the charging stations, local utility companies have to use fuel (e.g., oil, coal, etc.), which in turn generates vast amounts of pollution. However, with the development of ecologically clean technologies, some municipalities and/or companies chose to obtain their electrical power from wind, solar power or other ecologically clean technologies. However, municipalities and/or utility companies are not able to provide electrical power to all locations, especially those that are remote enough where running of conventional power lines is not a possibility. Thus, there is a need for a mobile charging station that can provide electrical power, wireless communication, and/or any other functionality to various equipment, vehicles, etc. that are dependent on it.

### SUMMARY

In some implementations, the current subject matter relates to a charging station. The charging station can include a housing having an interior portion and at least one movable panel for enclosing the interior portion. The movable panel(s) can include an energy receiving component and is being movable between a first position and a second position. In the first position, the energy receiving component can be exposed to an external energy source. In the second position, the energy receiving component can be enclosed in the interior portion of the housing.

In some implementations, the charging station can also include an electronic circuitry being disposed in the interior portion of the housing and connected to the energy receiving component, wherein the electronic circuitry receives energy from the energy receiving component and converts the received energy into an electrical energy.

In some implementations, the charging station can also include a first movable panel and a second movable panel, wherein the first movable panel includes a first energy receiving component and the second movable panel include a second energy receiving component, the first and second energy receiving components are connected to the electronic circuitry.

In some implementations, the housing can include a bottom portion, a top portion, a front wall portion and a back wall portion, wherein the interior portion of the housing is enclosed by the bottom portion, the top portion, the front and back wall portions and the at least one movable panel when the at least one movable panel is in the second position. The external energy source includes at least one of the following: a solar energy, a light energy, an electromechanical energy, an electromagnetic energy, an infrared energy, a wind energy, and an electrical energy.

In some implementations, the energy receiving component can include at least one solar panel.

In some implementations, the interior portion of the housing can be capable of receiving at least one equipment configured to receive electrical energy from the electronic circuitry. The equipment can include at least one of the following: a vehicle, a motorcycle, a scooter, a computing device, a wireless communication device, a mobile telephone, a smartphone, a tablet, a computer, a laptop, a server, a database, a construction equipment, a military equipment, a civilian equipment, a medical equipment, and a devices having a power source.

In some implementations, the charging station can also include a wireless communication equipment connected to the electronic circuitry for receiving and/or transmitting at least one wireless communication signal.

In some implementations, the movable panel can be rotatably coupled to the housing using at least one pivoting mechanism.

In some implementations, the housing can be manufactured from at least one of the following materials: metal, stainless steel, carbon fiber, fiberglass, Plexiglas, wood, plastics synthetics, concrete, high strength, low alloy steel, Niobium (Nb) alloy, and/or any other materials.

In some implementations, the current subject matter relates to a method of operating a charging station. The method can include providing a charging station (such as the one described above), placing the charging station in the first position, and generating, using the charging station, electrical power. The method can optionally include connecting at least one equipment to the charging station to receive electrical power. The equipment can include at least one of the following: a vehicle, a motorcycle, a scooter, a computing device, a wireless communication device, a mobile telephone, a smartphone, a tablet, a computer, a laptop, a server, a database, a construction equipment, a military equipment, a civilian equipment, a medical equipment, and a devices having a power source.

In some implementations, the current subject matter relates to a method of assembling a charging station. The method can include providing a housing having at least one of the following components: a side portion, a top portion, a bottom portion, a front portion and an electronic circuitry, and assembling the provided components into the charging station.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary charging station in a closed configuration, according to some implementations of the current subject matter;

FIG. 2 illustrates the charging station, shown in FIG. 1, in an open configuration, according to some implementations of the current subject matter;

FIG. 3 illustrates exemplary open configuration (shown in FIG. 2) and a closed configuration (shown in FIG. 1) of the charging station, according to some implementations of the current subject matter;

FIG. 4 illustrates another view of the charging station shown in FIG. 2, according to some implementations of the current subject matter;

FIG. 5 illustrates retractable power cords of the charging station, according to some implementations of the current subject matter;

FIG. 6 is a block diagram of an exemplary electronic circuitry of the charging station, according to some implementations of the current subject matter;

FIG. 7 illustrates an exemplary system, according to some implementations of the current subject matter;

FIG. 8 is a flow diagram illustrating an exemplary method for operating the station, according to some implementations of the current subject matter; and

FIG. 9 is a flow chart illustrating an exemplary process for assembling a charging station, according to some implementations of the current subject matter.

### DETAILED DESCRIPTION

To address the deficiencies of currently available solutions, one or more implementations of the current subject matter relate to a charging station having a housing. The housing can include an interior portion and at least one movable panel for enclosing the interior portion. The movable panel can include an energy receiving component and can be movable between a first position and a second position. In the first position, the energy receiving component can be exposed to an external energy source. In the second position, the energy receiving component can be enclosed in the interior portion of the housing. The energy receiving component can be a solar panel and/or any other equipment capable of receiving external energy from an external energy source and storing the received energy for subsequent transformation into an electrical energy, e.g., electrical current. The external energy source can include at least one of the following: sun and/or any other source of light and/or energy. The energy can include at least one of the following: a solar energy, a light energy, an electromechanical energy, an electromagnetic energy, an infrared energy, a wind energy, an electrical energy, and/or any other energy.

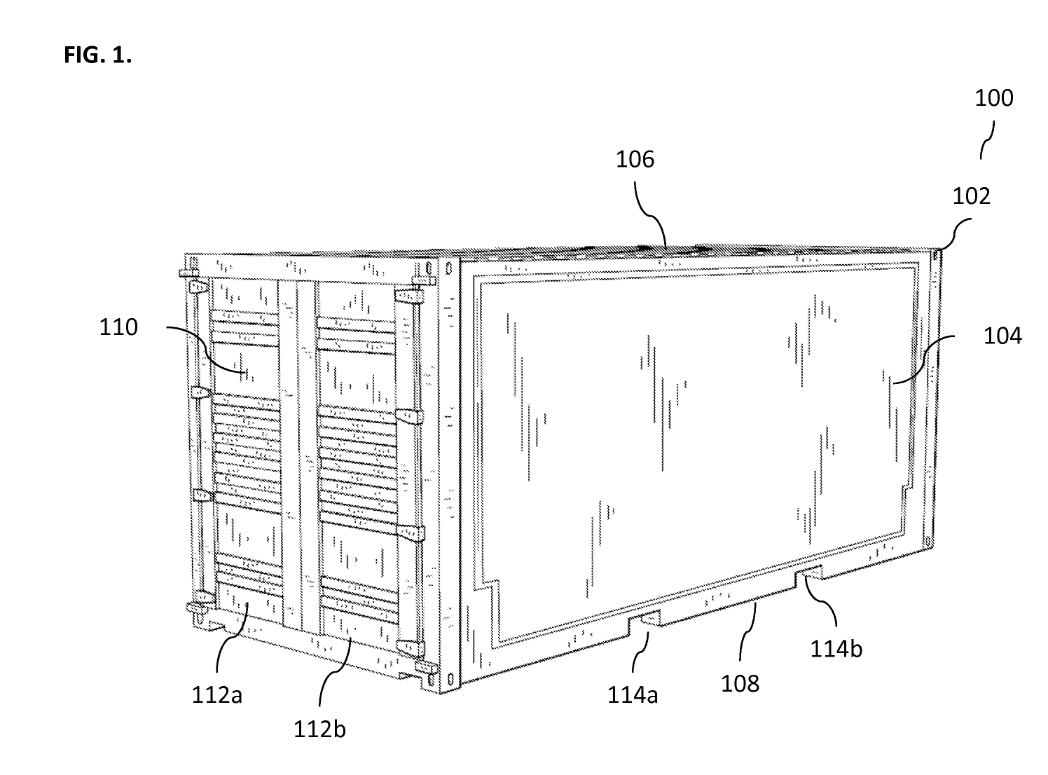

FIG. 1 illustrates an exemplary charging station 100 in a closed configuration, according to some implementations of the current subject matter. The station 100 can include a housing 102. The housing 102 can include a side portion 104 (another side portion can be opposite the side portion 104), a top portion 106, a bottom portion 108, and a front portion 110 (a back portion can be opposite the front portion 110) having doors 112(a, b). The housing 102 can include an interior portion (not shown in FIG. 1) that can be enclosed by the above portions. The interior of the housing 102 can contain various electronic equipment that can be used for conversion of energy into electrical power, communications (e.g., receiving and/or transmitting of wireless and/or wired signals). The interior portion of the housing 102 can be used to store various equipment that can use the electrical power generated by the station 100. The equipment can include at least one of the following: vehicles, motorcycles, scooters, computing devices (e.g., wireless communication devices, mobile telephones, smartphones, tablets, computers, laptops, servers, databases, etc.), construction equipment, military and/or civilian equipment, medical equipment, and any devices that may depend on electrical power for operation.

In some implementations, the housing 102 can be used to enclose energy receiving components (e.g., solar panels, etc.), where the energy receiving components (not shown in FIG. 1) can be coupled to the side portions 104. The housing 102 can enclose such energy receiving components when the station 100 is in a closed configuration, as shown in FIG. 1.

In some implementations, the bottom portion 108 of the housing 102 can include grooves 114(a, b) that can be used for transporting, stacking and/or otherwise securing the station 100 to a surface (e.g., a ground), to a logistical vehicle (e.g., a trailer truck, a boat, an airplane, etc.), to another station 100, and/or to any other object and/or surface, as desired. As can be understood, the station 100 is not limited to using grooves 114 for such purposes and other methods and/or devices/components can be used for these purposes.

In some implementations, the station 100 can have various shapes, which can include at least one of the following: a parallelepiped shape, a cube shape, a tetrahedron shape, a pyramidal shape, a spherical shape, and/or any other desired shape. As can be understood, the dimensions of the station 100 can be so chosen as to fit any need. For example, it can have the same size and/or shape as a standard shipping container, which can facilitate ease of shipment. Other shapes and/or sizes are possible.

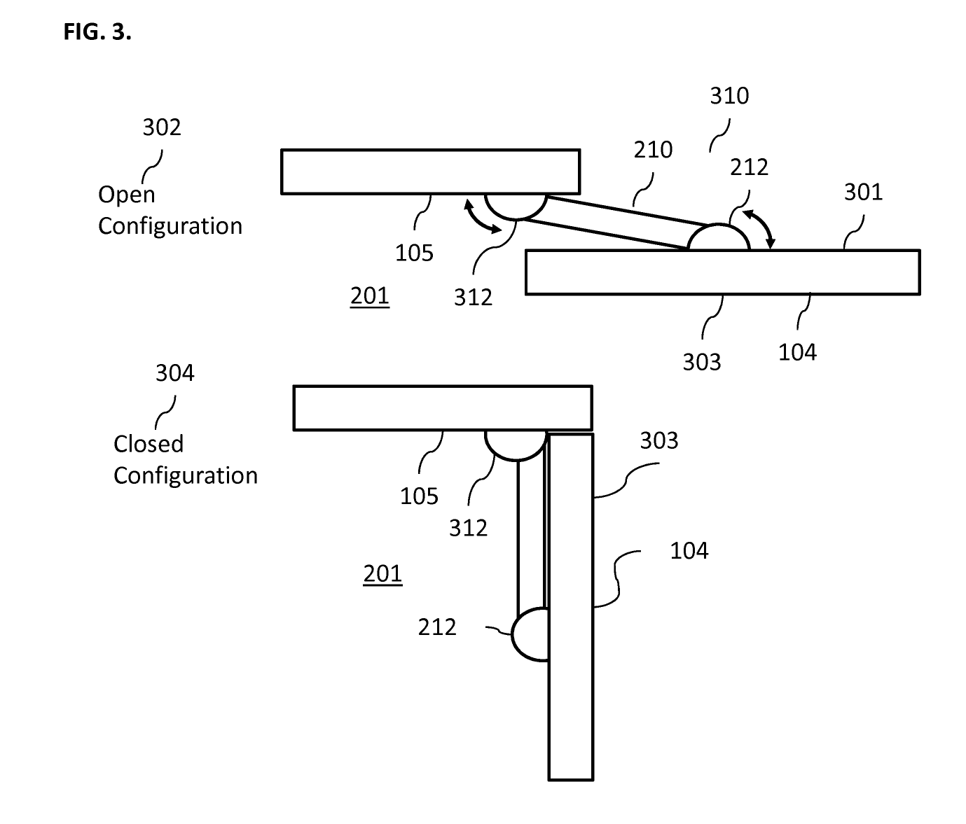

In some implementations, the station 100 and/or its components can be manufactured from any desired material(s). For example, the material(s) can include at least one of the following: metal, stainless steel, carbon fiber, fiberglass, Plexiglas, wood, plastics synthetics, concrete, high strength, low alloy steel, Niobium (Nb) alloy, and/or any other materials. In some implementations, one or more components of the station 100 can be reinforced with additional protective materials, for example, to prevent damage (e.g., rust, erosion, etc.), theft, etc., as well as to improve sustainability and/or continuous operability of the station 100 and/or its various components. In some implementations, the materials can be so selected to reduce weight of the station 100 and/or some and/or all of its components. Reduction in weight can allow reducing overall load on the mechanism (as shown in FIG. 3) that moves side portions 104. Further, the materials can provide additional security to the station 100 and/or some and/or all of its components (whether external and/or internal).

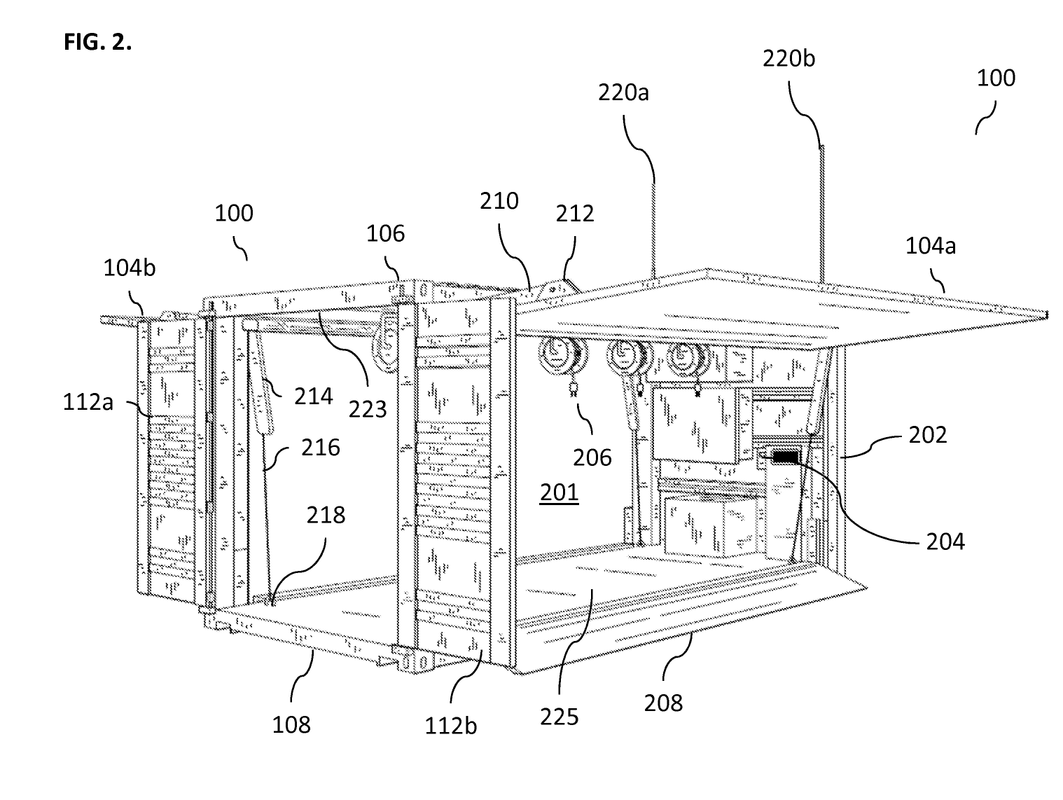

FIG. 2 illustrates the charging station 100, shown in FIG. 1, in an open configuration, according to some implementations of the current subject matter. In the open configuration, one or more of the side portions 104 (shown as 104(a, b)) can be open exposing the interior 201 of the station 100. In some implementations, to expose the interior 201 of the station 100, one or more of the doors 112 can be opened as well. In some implementations, the station 100 does not include doors 112, and thus, to access the interior of the station 100, side portions 104 may need to be opened. This can be accomplished using a key, a remote control, a security panel that may require entry of an access code to open the station 100, and/or using any other means.

In some implementations, the station 100 can include a wall 202 that can be located on the back portion of the station. The wall 202 can include various electronic circuitry 204 that can be used to operate the station 100 (e.g., generate electric power, transmit/receive/process wireless communications signals, etc.). The circuitry 204 will be described in more detail below. As can be understood, the circuitry 204 can be disposed in any location within the station 100 (whether internally and/or externally). The circuitry 204 can be coupled to energy receiving components (e.g., solar panels) (not shown in FIG. 2) for receiving energy and processing the received energy into electrical power. The circuitry 204 can provide that electric power to at least one retractable power cord 206. As shown in FIG. 2, the retractable power cord(s) 206 can be disposed on a ceiling 223 of the station 100 and can contain sufficient amount of wiring to reach the equipment being charged. However, as can be understood, the power cord(s) 206 can be disposed anywhere in the station 100 (whether internally and/or externally). The power cords can include one or more plugs that can be designed to fit any equipment that may require electric power for operation (whether to recharge and/or to operate directly off of the circuitry 204). Plug, transformer, etc. adaptors can be also available for the purposes of fitting such equipment. Additionally, the circuitry 204 can be coupled to any number of electrical outlets that can be disposed within the station 100.

In some implementations, equipment that may require recharging may be placed on a floor 225 of the station 100. The floor 225 can be made more easily accessible using at least one ramp 208 that can be extended from each side of the floor 225 (as shown in FIG. 2) upon placing the station 100 in the open configuration. The ramp(s) 208 can be extended manually (e.g., by hand), automatically, and/or activated hydraulically and/or by any other means. The ramp 208 can be retracted by the same means. Once the side portion 104 is in a closed position (as shown in FIG. 1), the ramp 208 can be substantially vertically positioned with respect to the floor 225. When the ramp 208 is in substantially vertical position, it can serve to protect integrity of the energy receiving components (e.g., solar panels) disposed on the side portion 104. This can be important during shipment of the station 100, which can also include equipment (e.g., scooters, vehicles, etc.) that may require electrical power for operation. This way, the equipment does not damage the energy receiving components during transporting.

As shown in FIG. 2, the station 100 can also include various antennas 220(a, b). The antennas can be used for communication purposes, including transmitting and/or receiving various signals, including radio frequency (“RF”) signals, and/or any other signals that can use any frequency band(s). The station 100 can be used as a wireless (and/or wired) communication station, a server, and/or any other type of communication equipment. The antennas 220 can be permanently coupled to the housing 102 of the station 100. Alternatively, the antennas 220 can be retractable and can be stored inside the housing 102 when they are not in use.

In some implementations, the side portions 104 can be coupled to the housing 102 of the station 100 using an arm 210. At its proximate end, the arm 210 can be pivotally coupled to the top portion 106 of the station 100. This first pivotal coupling (not shown in FIG. 2) can be secured inside the mobile station 100, e.g., by pivotally coupling the arm to the ceiling 223 of the station 100. At its distal end, the arm 210 can be pivotally coupled to a second pivot coupling 212 located on the side portion 104 that contains an energy receiving component (not shown in FIG. 2). To open the side portion 104 and expose the energy receiving component to a source of energy (e.g., sun), the arm 210 can include various hydraulic components that can cause rotation of the first and second pivotal couplings. The couplings can perform rotation simultaneously and/or one after another. The first pivotal coupling, by rotating, can extend the side portion 104 away from the housing 102 of the station 100 and the second pivotal coupling (i.e., coupling 212) can rotate the side portion 104 to bring it in a position that is substantially parallel to the top portion 106, as shown in FIG. 2. In some implementations, an arm 214 that can be coupled at its distal end to a side portion 104 and at its proximate portion to a string 216, which, in turn, is coupled to the floor 225 using a coupling mechanism 218, as shown in FIG. 2. To assist in closing of the side portion 104, the arm 214 pulls the string 216, which in turn, causes the proximate portion of the side portion 104 to rotate (using the pivotal couplings) downward toward the floor 225. Opening of the side portion 104 can be accomplished in a reverse fashion. Further details of the pivotal couplings and rotations of the side portion 104 are illustrated in FIG. 3 and discussed below.

FIG. 3 illustrates exemplary open configuration 302 (shown in FIG. 2) and closed configuration 304 (shown in FIG. 1). To switch between the open configuration and the closed configuration, an open/closed mechanism 310 can be used. The open/closed mechanism 310 can include a first pivoting mechanism 312, a second pivoting mechanism 212, and the arm 210 coupled to both mechanisms, as shown in FIG. 3. In addition to the components 210, 212, and 312, various hydraulic, mechanical, electrical mechanisms, and/or any other mechanisms and/or any combination thereof can be used to assist in operation of the open/close mechanism 310.

As shown in FIG. 3, the side portion 104 can include an interior portion 301 and an exterior portion 303. The interior portion 301 can contain energy receiving component(s) (not shown in FIG. 3). The exterior portion 303 can face the exterior of the station 100 when the station 100 is in a closed configuration 304. The first pivoting mechanism 312 can be coupled to the ceiling 105 of the station 100 and the second pivoting mechanism 212 can be coupled to the interior portion 301. In the open configuration 304, the interior portion 301 containing energy receiving component(s) can face an energy source (e.g., sun) and in the closed configuration 302, the interior portion 301 can face the interior 201 of the station 100.

To move the side portion 104 between open and closed configurations, the pivoting mechanisms 212 and 312 can rotate, as shown by the double arrows in FIG. 3. Rotations can be accomplished using various hydraulic, mechanical, electrical mechanisms, and/or any other mechanisms and/or any combination thereof that can be disposed in the arm 210 and/or the pivoting mechanisms 212, 312. In the open configuration 302, the side portion 104 can be substantially parallel to the ceiling 105 and, in the closed configured 304, the side portion 104 can be substantially perpendicular to the ceiling 105 of the station 100. Each side portion 104 can include one or more open/close mechanisms 310. As for example shown in FIG. 2, each side portion 104 can include two open/close mechanisms. The open/close mechanisms 310 of both side portions 104 can operate simultaneously, in sequence, and/or one at a time to expose the energy receiving components to the source of energy. In some implementations, the station 100 can include a sensor that can detect presence of energy (e.g., sun light) and send a signal to a processor contained in the electronic circuitry 204 to activate the open/close mechanism(s) 310 to expose the energy receiving components to the source of energy. Upon detection that the energy source is no longer available, the sensor may send a signal to the processor to cause the open/close mechanism(s) 310 to transform the station 100 into the closed configuration. In some implementations, additional security features (e.g., deadbolts) can be used in conjunction with the open/close mechanism(s) 310 to further secure the side portions 104, which can be useful for transportation purposes. In some implementations, the open/close mechanism 310 can include various hydraulic components, mechanical winches and/or cranks, and/or any other components. The mechanism 310 can also include stop points for the side portions 104, which can be secured by snapping metal bolts and/or tubes that can be inserted into reinforced holes and/or stops.

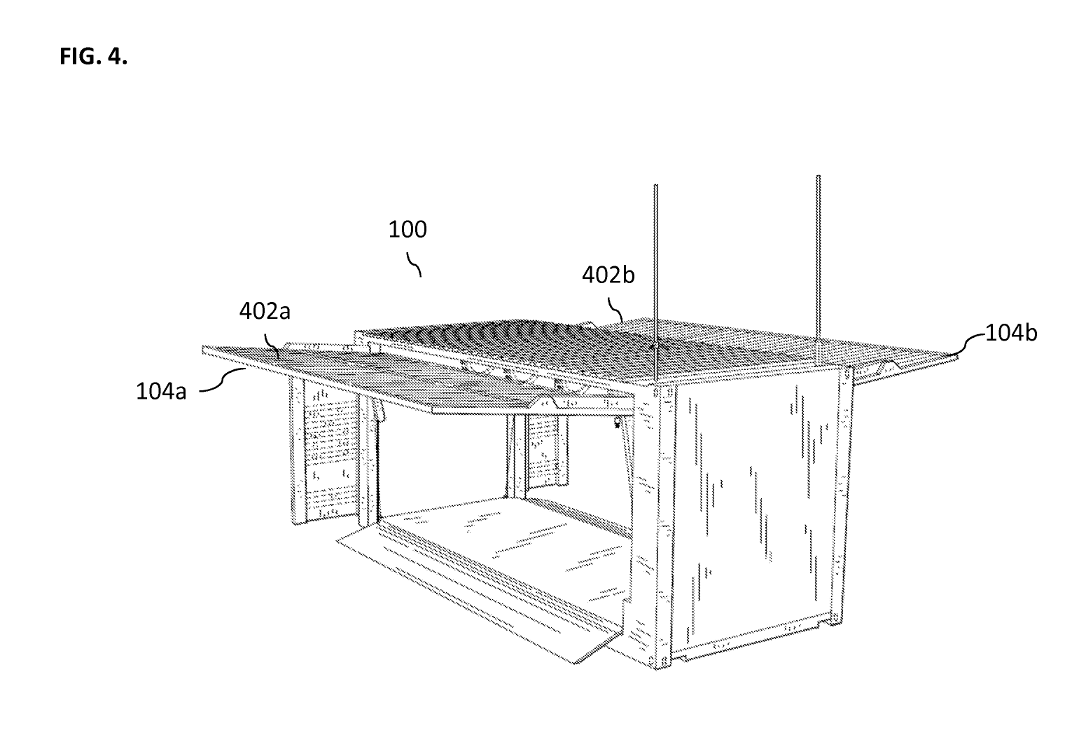

FIG. 4 illustrates another view of the charging station 100 shown in FIG. 2, according to some implementations of the current subject matter. As stated above, the charging station 100 can include side portions or movable panels 104(a, b). The side portion 104a can include an energy receiving component 402a and the side portion 104b can include an energy receiving component 402b. The energy receiving components 402 can include at least one solar panel and/or multiple solar panels. Any known solar panels and/or any number of solar panels can be used. The solar panels 402 can be mechanically coupled to the side portions 104 using any known methods. The panels 402 can be electrically coupled to the electronic circuitry 204 (not shown in FIG. 4) using any known methods as well. The panels 402 can be designed to receive energy and transform it to the electronic circuitry for generating electric power, as described below.

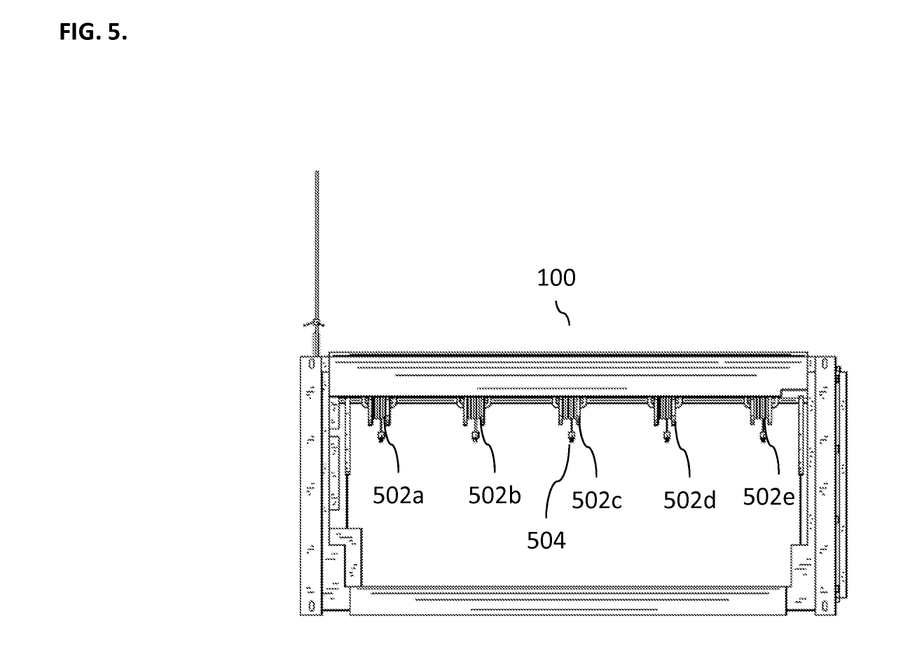

FIG. 5 illustrates exemplary retractable power cords 502(a, b, c, d, e) disposed in the charging station 100, according to some implementations of the current subject matter. Each retractable power cord can include a roller wheel that can be coupled to the ceiling 105 of the station 100. The roller wheel can include a wound electrical wire 504 that can extend a sufficient length to reach the equipment being charged and/or operated using the station 100. The electrical wire 504 can also include an electrical plug and/or a receiving electrical outlet that can be either plugged into the equipment being charged and/or connected to another electrical wire. In some implementations, various adaptors can be used to facilitate connection between the electrical wire 504 and the equipment being charged. The electrical wire 504 can be coupled to the electronic circuitry 204 (not shown in FIG. 5) for receiving electrical power from it. In some implementations, the electrical wire 504 can include appropriate shielding to prevent external interference as well as to prevent interference with other components of the station 100. In some implementations, the electrical wire 504 can be used to carry any strength current at any desired voltage that can be suitable for charging and/or operating any equipment. In some implementations, power cords 502 can include electrical wires that can carry different current/voltage to allow different equipment to connect to an appropriate current/voltage for charging/operating. The power cords 502 can be appropriately marked to easily distinguish between them.

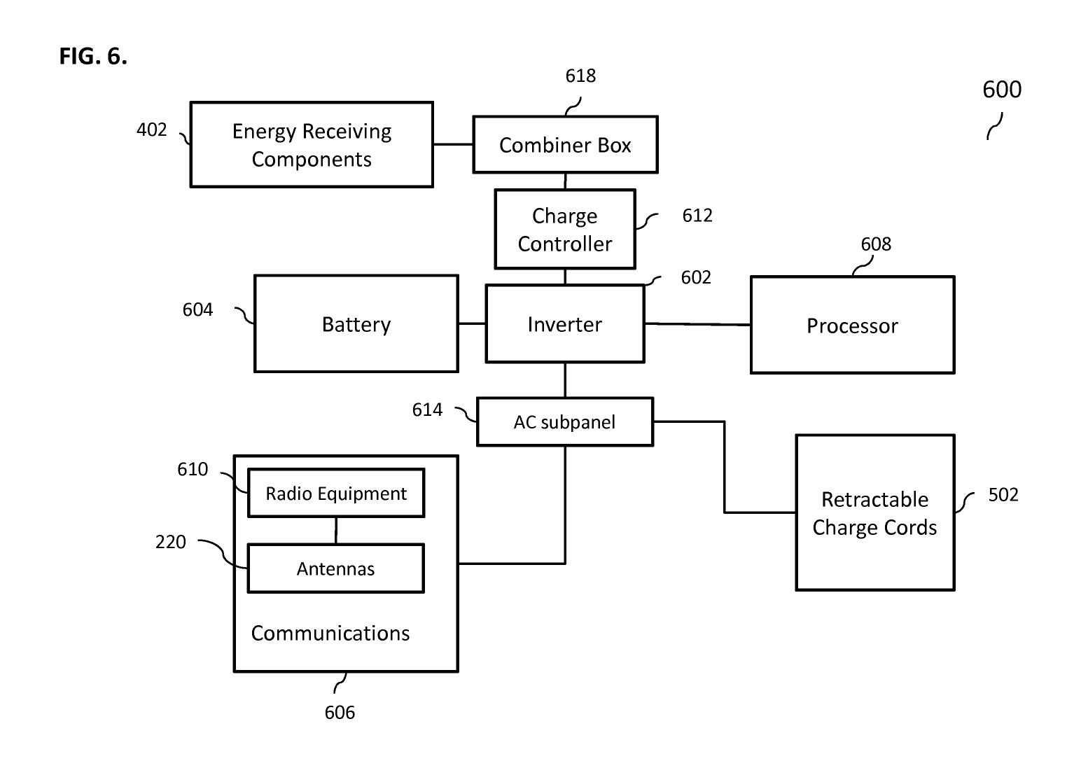

FIG. 6 is a block diagram of an exemplary electronic circuitry 600 of the charging station 100, according to some implementations of the current subject matter. The electronic circuitry 600 can include an inverter block 602, a battery storage block 604, a communications block 606, a processor block 608, a combiner block 618, a charger controller block 612, and an AC subpanel block 614. The circuitry 600 can be coupled to the energy receiving components or panels 402 and retractable power cords 502 (discussed above with regard to FIGS. 4 and 5, respectively). The inverter 602 can be coupled to energy receiving components 402, the battery storage block 604, the communications block 606, the processor block 608, the combiner box 618 and the charge controller block 612. The wires 504 of the power cords 502 can be also coupled to the AC sub-panel. The inverter 602 can receive energy from the energy receiving components 402 and can convert the received energy into an electrical energy or power. The electrical energy can then be stored in the battery storage block 604. The combiner box 618 and the charge controller 612 can be used to control conversion of the received energy as well as storage of the electrical power in the battery storage component 604.

In some implementations, the communications block 606 can be coupled to the AC subpanel 614, and can include a radio equipment (e.g., RF) 610 as well as antennas 220 (as shown in FIG. 2). The communications block 606 can be coupled to the AC sub-panel 614 for receiving electrical power to allow the communications block 606 to transmit and/or receive signals. The signals can be communicated using various frequency bands. The communications block 606 can be used to communicate with one or more equipment that may be located externally to the station 100, which can include at least one of the following: vehicles, motorcycles, scooters, computing devices (e.g., wireless communication devices, mobile telephones, smartphones, tablets, computers, laptops, servers, databases, etc.), construction equipment, military and/or civilian equipment, medical equipment, and any other devices.

In some implementations, the processor block 608 can be used to control operation of the station 100. The processor block 608 can include at least one processor coupled to at least one memory. The processor block 608 can also include various input/output devices (e.g., monitor, mouse, keyboard, etc.). The processor block 608 can perform monitoring of use of the station 100 and amount of electrical power generated, stored and/or dispensed. It can also operate in conjunction with the communications block 606 for providing communications capabilities to the station 100. The processor block 608 can also store identification information for the station and provide electronic security to the components and/or perform any other functions. The processor block 608 can include a system display to display the status of the station 100. Each of the components in the electronic circuitry 600 can be appropriately secured to the station 100. A shielding (e.g., protective housings) can be implemented to protect each component of the electronic circuitry from damage, vandalism, etc. In some implementations, the station 100 can be appropriately grounded to prevent occurrences of electrical shock and/or short circuit.

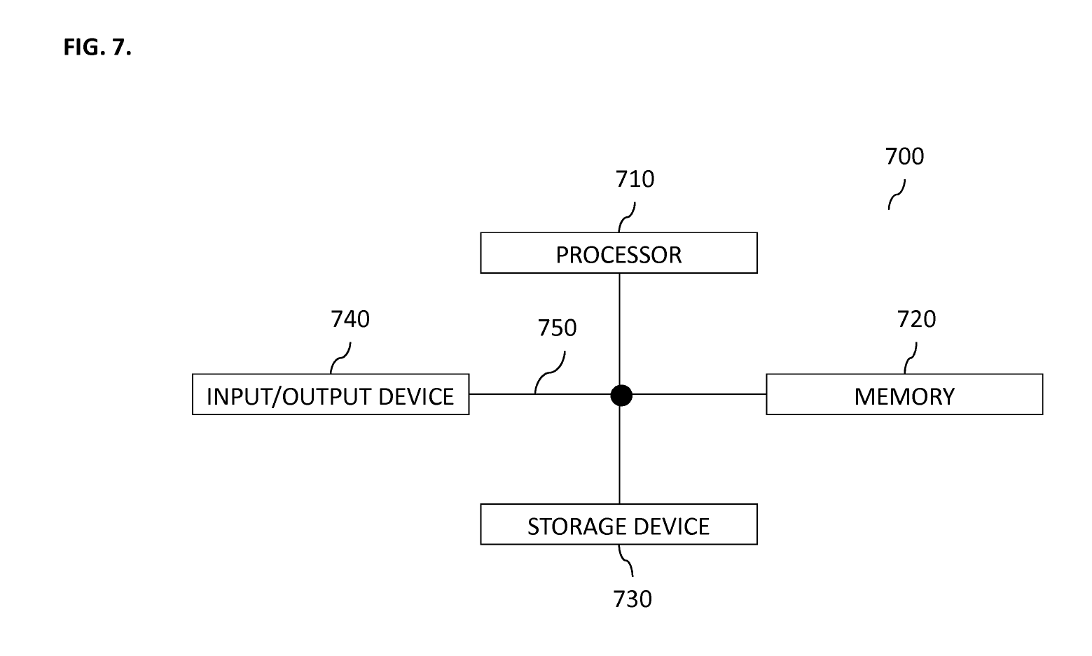

In some implementations, the processing block 608 can be configured to be implemented in a system 700, as shown in FIG. 7. The system 700 can include one or more of a processor 710, a memory 720, a storage device 730, and an input/output device 740. Each of the components 710, 720, 730 and 740 can be interconnected using a system bus 750. The processor 710 can be configured to process instructions for execution within the system 700. In some implementations, the processor 710 can be a single-threaded processor. In alternate implementations, the processor 710 can be a multi-threaded processor. The processor 710 can be further configured to process instructions stored in the memory 720 or on the storage device 730, including receiving or sending information through the input/output device 740. The memory 720 can store information within the system 700. In some implementations, the memory 720 can be a computer-readable medium. In alternate implementations, the memory 720 can be a volatile memory unit. In yet some implementations, the memory 720 can be a non-volatile memory unit. The storage device 730 can be capable of providing mass storage for the system 700. In some implementations, the storage device 730 can be a computer-readable medium. In alternate implementations, the storage device 730 can be a floppy disk device, a hard disk device, an optical disk device, a tape device, non-volatile solid state memory, or any other type of storage device. The input/output device 740 can be configured to provide input/output operations for the system 700. In some implementations, the input/output device 740 can include a keyboard and/or pointing device. In alternate implementations, the input/output device 740 can include a display unit for displaying graphical user interfaces.

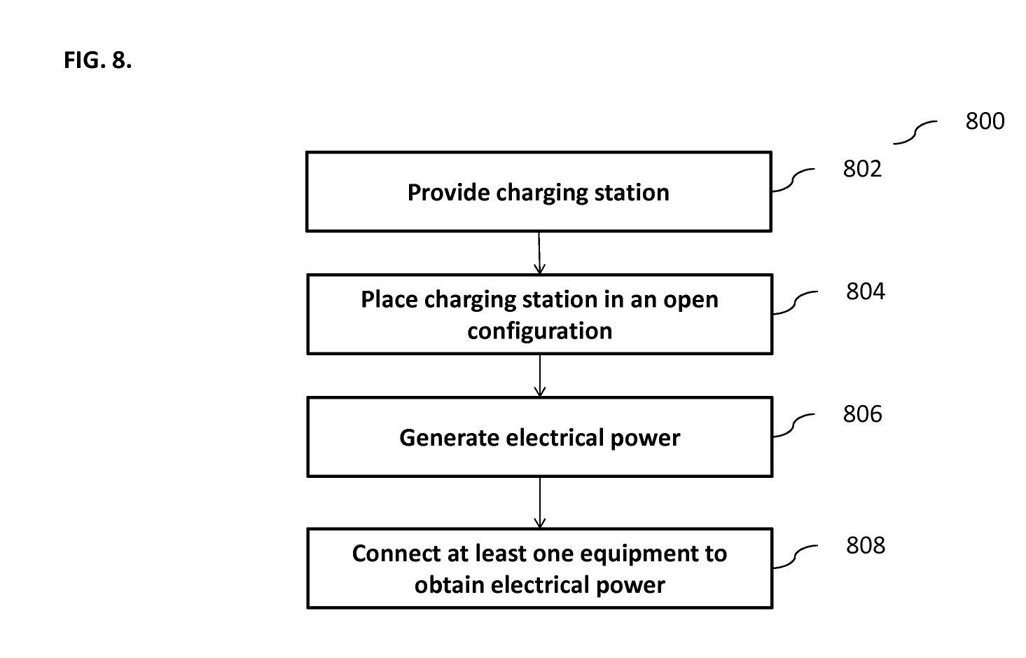

FIG. 8 is a flow diagram illustrating an exemplary method 800 for operating the station 100, according to some implementations of the current subject matter. At 802, a charging station (e.g., station 100 shown in FIGS. 1-7 above) can be provided. The station can be transported to a predetermined location and placed on a surface. If desired, the station 100 can be secured to the surface using various known methods. The surface can be ground (e.g., a location in a desert), roof of a building, and/or any other surface in any location. At 804, the station can be placed in an open configuration, such as by opening the side portions 104 and exposing the energy receiving components to a source of energy. At 806, the station 100 can generate electrical power once the energy receiving components are exposed to the source of energy. The power can be generated by converting the received energy into an electrical energy using electronic circuitry 600 (shown in FIG. 6). Optionally, at 808, at least one equipment (e.g., vehicles, motorcycles, scooters, computing devices (e.g., wireless communication devices, mobile telephones, smartphones, tablets, computers, laptops, servers, databases, etc.), construction equipment, military and/or civilian equipment, medical equipment, and/or any other devices) can connect (whether using wired and/or wireless means) to for the purposes of charging its battery(ies).

In some implementations, the current subject matter can include one or more of the following features.

The charging station can include a housing having an interior portion and at least one movable panel for enclosing the interior portion. The movable panel(s) can include an energy receiving component and can be movable between a first position and a second position. In the first position, the energy receiving component can be exposed to an external energy source. In the second position, the energy receiving component can be enclosed in the interior portion of the housing. The station can also include an electronic circuitry being disposed in the interior portion of the housing and connected to the energy receiving component. The electronic circuitry can receive energy from the energy receiving component and convert the received energy into an electrical energy. The station can also include a first movable panel and a second movable panel. The first movable panel can include a first energy receiving component. The second movable panel can include a second energy receiving component. The first and second energy receiving components can be connected to the electronic circuitry.

In some implementations, the housing can include a bottom portion, a top portion, a front wall portion and a back wall portion. The interior portion of the housing can be enclosed by the bottom portion, the top portion, the front and back wall portions and the movable panel(s) when the movable panel(s) is/are in the second position.

In some implementations, the external energy source can include at least one of the following: a solar energy, a light energy, an electromechanical energy, an electromagnetic energy, an infrared energy, a wind energy, and an electrical energy. In some implementations, the energy receiving component can include at least one solar panel.

In some implementations, the interior portion of the housing can be capable of receiving at least one equipment configured to receive electrical energy from the electronic circuitry. The equipment can include at least one of the following: an electric vehicle, an electric scooter, a power generating device, a mobile device, a computing device, a medical device, and any electrically powered device.

In some implementations, the station can include a communication equipment connected to the electronic circuitry for receiving and/or transmitting at least one communication signal.

In some implementations, the movable panel(s) is/are rotatably coupled to the housing using at least one pivoting mechanism.

In some implementations, the housing can be manufactured from at least one of the following materials: metal, stainless steel, carbon fiber, fiberglass, Plexiglas, wood, plastics synthetics, concrete, high strength, low alloy steel, Niobium (Nb) alloy, and/or any other materials.

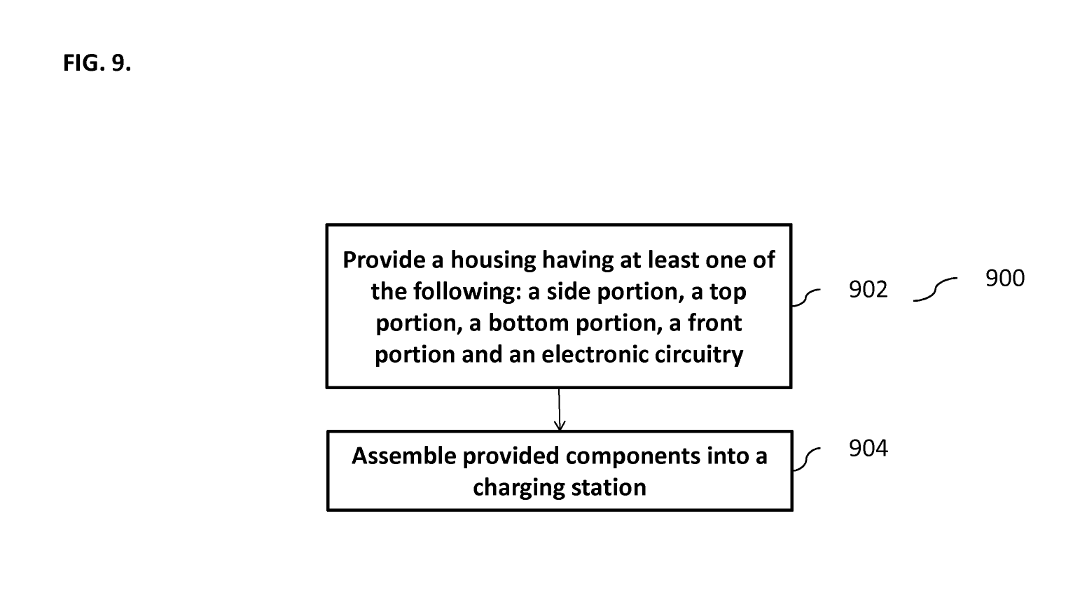

FIG. 9 is a flow chart illustrating an exemplary process 900 for assembling a charging station (such as station 100 shown in FIGS. 1-7), according to some implementations of the current subject matter. At 902, a housing having a side portion, a top portion, a bottom portion, a front portion (such as those shown in FIG. 1) and an electronic circuitry (as shown in FIG. 6) can be provided. The side portions can include energy receiving components (e.g., solar panels). The electronic circuitry can be coupled to the energy receiving components and power cords (such as those shown in FIG. 5). At 904, the provided components can be assembled into the charging station.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

The subject matter described herein may be embodied in systems, apparatus, methods, and/or articles depending on the desired configuration. In particular, various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A charging station, comprising:
a housing having
an interior portion;
at least one movable panel for enclosing the interior portion;
the at least one movable panel including an energy receiving component and is being movable between a first position and a second position, wherein in the first position, the energy receiving component is exposed to an external energy source and in the second position, the energy receiving component is enclosed in the interior portion of the housing.

2. The charging station according to claim 1, further comprising
an electronic circuitry being disposed in the interior portion of the housing and connected to the energy receiving component, wherein the electronic circuitry receives energy from the energy receiving component and converts the received energy into an electrical energy.

3. The charging station according to claim 1, further comprising a first movable panel and a second movable panel, wherein the first movable panel includes a first energy receiving component and the second movable panel include a second energy receiving component, the first and second energy receiving components are connected to the electronic circuitry.

4. The charging station according to claim 1, wherein the housing includes a bottom portion, a top portion, a front wall portion and a back wall portion, wherein the interior portion of the housing is enclosed by the bottom portion, the top portion, the front and back wall portions and the at least one movable panel when the at least one movable panel is in the second position.

5. The charging station according to claim 1, wherein the external energy source includes at least one of the following: a solar energy, a light energy, an electromechanical energy, an electromagnetic energy, an infrared energy, a wind energy, and an electrical energy.

6. The charging station according to claim 1, wherein the energy receiving component includes at least one solar panel.

7. The charging station according to claim 2, wherein the interior portion of the housing is capable of receiving at least one equipment configured to receive electrical energy from the electronic circuitry.

8. The charging station according to claim 7, wherein the at least one equipment includes at least one of the following: a vehicle, a motorcycle, a scooter, a computing device, a wireless communication device, a mobile telephone, a smartphone, a tablet, a computer, a laptop, a server, a database, a construction equipment, a military equipment, a civilian equipment, a medical equipment, and a devices having a power source.

9. The charging station according to claim 2, further comprising a wireless communication equipment connected to the electronic circuitry for receiving and/or transmitting at least one wireless communication signal.

10. The charging station according to claim 1, wherein the at least one movable panel is rotatably coupled to the housing using at least one pivoting mechanism.

11. The charging station according to claim 1, wherein the housing is manufactured from at least one of the following materials: metal, stainless steel, carbon fiber, fiberglass, Plexiglas, wood, plastics synthetics, concrete, high strength, low alloy steel, and Niobium (Nb) alloy.

12. A method of operating a charging station, comprising
providing a charging station, the charging station including
a housing having
an interior portion;
at least one movable panel for enclosing the interior portion;
the at least one movable panel including an energy receiving component and is being movable between a first position and a second position, wherein in the first position, the energy receiving component is exposed to an external energy source and in the second position, the energy receiving component is enclosed in the interior portion of the housing;
placing the charging station in the first position; and
generating, using the charging station, electrical power.

13. The method according to claim 12, further comprising
connecting at least one equipment to the charging station to receive electrical power.

14. The method according to claim 13, wherein the at least one equipment includes at least one of the following: a vehicle, a motorcycle, a scooter, a computing device, a wireless communication device, a mobile telephone, a smartphone, a tablet, a computer, a laptop, a server, a database, a construction equipment, a military equipment, a civilian equipment, a medical equipment, and a devices having a power source.

15. The method according to claim 12, wherein the housing includes
an electronic circuitry being disposed in the interior portion of the housing and connected to the energy receiving component, wherein the electronic circuitry receives energy from the energy receiving component and converts the received energy into an electrical energy.

16. The method according to claim 12, wherein the housing includes a first movable panel and a second movable panel, wherein the first movable panel includes a first energy receiving component and the second movable panel include a second energy receiving component, the first and second energy receiving components are connected to the electronic circuitry.

17. The method according to claim 12, wherein the housing includes a bottom portion, a top portion, a front wall portion and a back wall portion, wherein the interior portion of the housing is enclosed by the bottom portion, the top portion, the front and back wall portions and the at least one movable panel when the at least one movable panel is in the second position.

18. The method according to claim 12, wherein the external energy source includes at least one of the following: a solar energy, a light energy, an electromechanical energy, an electromagnetic energy, an infrared energy, a wind energy, and an electrical energy.

17. The method according to claim 1, wherein the energy receiving component includes at least one solar panel.

18. The method according to claim 15, wherein the interior portion of the housing is capable of receiving at least one equipment configured to receive electrical energy from the electronic circuitry.

19. The method according to claim 15, wherein the housing includes a wireless communication equipment connected to the electronic circuitry for receiving and/or transmitting at least one wireless communication signal.

20. The method according to claim 12, wherein the at least one movable panel is rotatably coupled to the housing using at least one pivoting mechanism.

21. The method according to claim 12, wherein the housing is manufactured from at least one of the following materials: metal, stainless steel, carbon fiber, fiberglass, Plexiglas, wood, plastics synthetics, concrete, high strength, low alloy steel, and Niobium (Nb) alloy.

22. A method of assembling a charging station, comprising
providing a housing having at least one of the following components: a side portion, a top portion, a bottom portion, a front portion and an electronic circuitry; and
assembling the provided components into the charging station.
